(19) United States
(12) Patent Application Publication
(10) Pub. No.: US 2025/0100355 A1
(43) Pub. Date: Mar. 27, 2025

(54) ASSEMBLY AND METHOD FOR MOVING A COVER

(71) Applicant: Webasto SE, Stockdorf (DE)

(72) Inventors: Julian KNÖPFLE, Stockdorf (DE); Maciej KACZMAREK, Stockdorf (DE)

(21) Appl. No.: 18/833,657

(22) PCT Filed: Feb. 7, 2023
(86) PCT No.: PCT/EP2023/052954

§ 371 Date: Jul. 26, 2024

(30) Foreign Application Priority Data
Mar. 1, 2022 (DE) 10 2022 104 795.4

(51) Int. Cl. B60J 7/043; B60J 7/19

(52) U.S. Cl. CPC B60J 7/0435; B60J 7/192

(57) ABSTRACT

An assembly for moving a cover for a vehicle roof has —a guide rail which extends in a longitudinal direction, —a slotted-guide housing which has a slotted-guide portion that extends in an elongate manner in the longitudinal direction, wherein a locking slotted guide is formed in the slotted-guide portion, wherein the locking slotted guide has a helical shape, —a deployment element having a radially protruding locking protrusion which cooperates with the locking slotted guide in order to rotate the locking protrusion about the longitudinal direction during operation, wherein—the slotted-guide housing has a radially protruding region and the guide rail has a recess, and the protruding region is arranged in the recess in an assembled state.

### CROSS-REFERENCE TO RELATED APPLICATIONS

This application is a U.S. national phase application filed under 35 U.S.C. § 371 of International Application No. PCT/EP2023/052954, filed on Feb. 7, 2023, published under WO 2023/165789 A1 on Sep. 7, 2023, designating the United States, which claims priority from German Patent Application Number 10 2022 104 795.4, filed on Mar. 1, 2022, which are hereby incorporated herein by reference in their entirety.

### FIELD

An assembly for moving a cover for a vehicle roof is disclosed. In addition, a method for moving a cover for a vehicle roof is disclosed.

### BACKGROUND

Assemblies of this kind, having a cover for a vehicle roof, serve for example, for the purpose of opening starting from a closed position closing a roof opening, to first of all lift the cover in the rear region thereof by way of a deployment mechanism and then to displace it rearwardly into an open position. DE 10 2006 045 632 B3 describes for example a so-called spoiler roof in this regard.

It is desirable to propose an assembly for moving a cover for a vehicle roof, said assembly allowing reliable operation. It is additionally desirable to propose a method for moving a cover for a vehicle roof, said method being able to be carried out reliably.

### SUMMARY

An assembly for moving a cover for a vehicle roof has a guide rail. The guide rail extends in a longitudinal direction. The assembly has a slotted-guide housing. The slotted-guide housing, which is made for example from a plastic, has a slotted-guide portion that extends in an elongate manner in the longitudinal direction. A locking slotted guide is formed in the slotted-guide portion. The locking slotted guide has a helical shape. In particular, the locking slotted guide extends in a spiral shape. The shape of the locking slotted guide can also be referred to as screw-shaped. In particular, the pitch or the radius of the locking slotted guide changes along its course. In this regard, it is possible for the course of the locking slotted guide to differ from an ideal helix.

The assembly has a deployment element. The deployment element has a radially protruding locking protrusion. The deployment element extends in an elongate manner in particular in the longitudinal direction.

During operation, the locking protrusion cooperates with the locking slotted guide in order to rotate the locking protrusion about the longitudinal direction during operation. By means of the rotatable locking protrusion, it is thus possible to lock the deployment element relative to the guide slotted guide. In a corresponding manner, it is, for example, also possible, by means of the rotation of the locking protrusion, to enable displacement of the deployment element in the longitudinal direction relative to the guide rail.

The slotted-guide housing has a radially protruding region. The protruding region is arranged for example on the slotted-guide portion. The guide rail has a recess. The protruding region is arranged in the recess in an assembled state.

By means of the protruding region, the slotted-guide housing and in particular the slotted-guide portion are supported on the guide rail. Support transversely to the longitudinal direction is able to be brought about by the engagement of the radially protruding region in the recess in the guide rail. The protruding region protrudes radially and is thus oriented transversely to the longitudinal direction. For example, the radially protruding region extends, in the assembled state, in a vertical direction and passes, in the recess, through a profile wall of the guide rail. The profile wall is interrupted by the recess in the vertical direction and the profile wall delimits the recess in the longitudinal direction.

The slotted-guide housing is held and supported reliably and stably in the guide rail. Deformation on account of the forces that arise during operation can thus be avoided. The slotted-guide housing is easy to mount on and fasten to the guide rail. The slotted-guide housing and in particular the slotted-guide portion are robustly supported and the loads that arise in the slotted-guide portion and on the locking slotted guide during operation are reliably transferred to the guide rail. Undesired deformation of the slotted-guide portion and of the locking slotted guide can thus be avoided.

According to at least one embodiment, the protruding region has two stops for the locking protrusion. A first portion of the locking slotted guide is arranged between the two stops in the longitudinal direction. The two stops protrude beyond the slotted-guide portion in particular radially with respect to the longitudinal direction. When the locking protrusion is arranged between the two stops, the locking protrusion and thus the deployment element are locked relative to the slotted-guide housing in the X direction. The locking protrusion is arranged between the two stops when it is arranged in the first portion of the locking slotted guide. In the longitudinal direction, the movement of the locking protrusion is thus blocked in both directions by means of the two stops.

According to at least one embodiment, the locking protrusion is arranged, in a locked state, between the two stops in the longitudinal direction. The two stops are supported on the guide rail at their respective sides facing away from the locking protrusion in the longitudinal direction. The two stops of the slotted-guide housing are in particular in contact with the profile wall that delimits the recess. It is thus possible for forces, in particular forces in the X direction, to be transferred to the guide rail by the stops. Loads that act on the stops during operation, for example on account of the locking protrusion, can thus be diverted directly into the guide rail. When the deployment element is loaded in the longitudinal direction X in the locked state during operation, this loading is transferred to at least one of the two stops and transferred from there to the guide rail.

According to at least one embodiment, the slotted-guide housing has an assembling recess. The assembling recess is connected to the locking slotted guide. By means of the assembling recess, the locking protrusion is able to be introduced into the locking slotted guide. During operation, the locking protrusion moves in particular only in the locking slotted guide. In particular, in the assembled state, the assembling recess is closed by means of the guide rail, and so, in the assembled state, the locking protrusion cannot pass back into the assembling recess. Before the slotted-guide housing has been assembled on the guide rail, the assembling recess is accessible. The assembling recess is thus connected to the locking slotted guide such that the locking protrusion is able to be inserted into the locking slotted guide through the assembling recess. Thus, simple assembly is created and a stable slotted-guide housing and a stable slotted-guide portion are created.

According to at least one embodiment, the slotted-guide housing has a lifting slotted guide for lifting and lowering the cover. Both the lifting slotted guide and the locking slotted guide are formed in the common component that is the slotted-guide housing. The slotted-guide housing is, in particular, a plastics part formed in one piece, in which, for example, both the locking slotted guide and the lifting slotted guide are arranged. A slider, for example, engages in the lifting slotted guide during operation, said slider being assigned to a front edge of the cover. When the slider moves along the lifting slotted guide, the front edge of the cover is lifted or lowered.

According to at least one embodiment, the guide rail has a guide channel. The deployment element is guided in the guide channel. The slotted-guide portion of the slotted-guide housing is arranged at least partially in the guide channel. In particular, the guide channel is designed such that the guide channel guides and supports the deployment element during operation, such that it is possible to displace the deployment element in the longitudinal direction relative to the guide rail. In addition, by means of the guide channel, a situation is avoided in which the deployment element is undesirably deformed, for example under compressive load.

The slotted-guide portion is arranged entirely or partially in the guide channel. Thus, engaging support of the slotted-guide portion in the guide rail is brought about. Forces that arise during operation can be diverted directly into the guide rail. Undesired deformation of the slotted-guide portion is thus avoidable. In particular, the slotted-guide portion is thus able to be designed with a small space requirement since the slotted-guide portion, considered on its own, does not need to be able to take up all of the loads that arise during operation. Cooperating with the guide rail in the assembled the state, slotted-guide portion is nevertheless stable enough. Additional reinforcements, for example solid metal inserts for stabilizing the slotted-guide portion, can also be avoided as a result.

According to at least one embodiment, the guide channel has a first cross section transversely to the longitudinal direction. The guide channel has a second cross section in an end portion facing the slotted-guide housing. The second cross section is larger than the first cross section. The slotted-guide portion is arranged in the end portion. For example, the larger second cross section is introduced into the guide channel by drilling or milling. For example, on its inner side the guide channel has profiling that defines the first cross section. This profiling is removed, for example, in order to create the second cross section. The slotted-guide portion also has, for example, the first cross section on its inner side. Thus, the deployment element is reliably guided in the guide channel with the first cross section and the slotted-guide portion. A transition between the guide channel and the slotted-guide portion is reliably created.

According to at least one embodiment, the slotted-guide portion has a circular cylindrical shape. Thus, the slotted-guide portion is easy to arrange in the end portion of the guide channel. Radial diversion of the loads that arise during operation to the guide rail is reliably possible.

According to one embodiment, a method for assembling an assembly for moving a cover for a vehicle roof comprises providing a guide rail. The guide rail extends in a longitudinal direction. A slotted-guide housing is provided. The slotted-guide housing has a slotted-guide portion, extending in an elongate manner in the longitudinal direction, in a radially protruding region. The slotted-guide housing is inserted into the guide rail. The slotted-guide housing is rotated about the longitudinal direction until the protruding region is arranged in a recess in the guide rail. Thus, the slotted-guide housing is locked in place in the guide rail at least in the longitudinal direction. Assembling the slotted-guide housing on the guide rail by means of insertion and rotation allows a simple assembly concept for the slotted-guide portion in the guide rail. The slotted-guide portion is able to assembled and able to be attached to the guide rail such that the forces and loads that arise during operation can be transferred reliably from the slotted-guide portion to the guide rail. Large openings in the guide rail or in other components can be avoided and thus the stability of assembly can be configured in a reliable manner.

By way of example, the method serves for assembling an assembly described herein, according to the various embodiments and exemplary embodiments. The developments and advantages described in relation to the assembly thus also apply to the method and vice versa.

According to at least one embodiment, a deployment element having a radially protruding locking protrusion is provided. The locking protrusion is introduced into a locking slotted guide, wherein the locking slotted guide is formed in the slotted-guide portion. The introduction of the locking protrusion takes place before the slotted-guide housing is locked in place in the guide rail. For example, an assembling recess in the slotted-guide portion is freely accessible before the slotted-guide housing is locked in place in the guide rail. The locking protrusion is introduced into the locking slotted guide of the slotted-guide portion by means of the assembling recess. Then, the slotted-guide portion is inserted into the guide rail and rotated until it is locked in place. The assembling recess is then closed in particular by means of the guide rail.

By way of example, the slotted-guide housing having the slotted-guide portion is provided, in which the locking slotted guide is formed. The locking slotted guide is helical.

The locking and unlocking of the deployment element relative to the guide rail thus take place by means of rotation of the locking protrusion. This allows reliable locking.

According to embodiments, the assembly is part of a spoiler roof, in which, at a rear edge in the opening direction, first of all a deployment lever is turned in order to lift the rear edge of the cover. The cover is displaced in the opening direction relative to the deployment lever in order to at least partially open up the roof opening. The deployment lever is fixed relative to the rest of the vehicle roof in this case, and not displaced in the opening direction together with the cover.

According to embodiments, the assembly is part of an externally guided sliding roof, in which the deployment lever at the rear edge of the cover is displaced together with the cover in the opening direction relative to the rest of the vehicle roof.

Further advantages, features and developments will become apparent from the following examples, which are explained in conjunction with the figures. Elements that are identical, similar and have the same action can be provided with the same reference signs throughout the figures.

### BRIEF DESCRIPTIONS OF THE DRAWINGS

In the figures:

FIG. 1 shows a schematic illustration of a vehicle according to one exemplary embodiment,

FIG. 2 shows a schematic illustration of an assembly according to one exemplary embodiment,

FIG. 3 shows a schematic illustration of a slotted-guide housing according to one exemplary embodiment,

FIG. 4 shows a schematic illustration of a slotted-guide housing according to one exemplary embodiment,

FIG. 5 shows a schematic illustration of a slotted-guide housing according to one exemplary embodiment,

FIG. 6 shows a schematic illustration of an assembly according to one exemplary embodiment,

FIG. 7 shows a schematic illustration of a slotted-guide housing and of a deployment element according to one exemplary embodiment,

FIG. 8 shows a schematic illustration of a guide rail according to one exemplary embodiment, and

FIG. 9 shows a schematic illustration of an assembly according to one exemplary embodiment.

### DETAILED DESCRIPTION

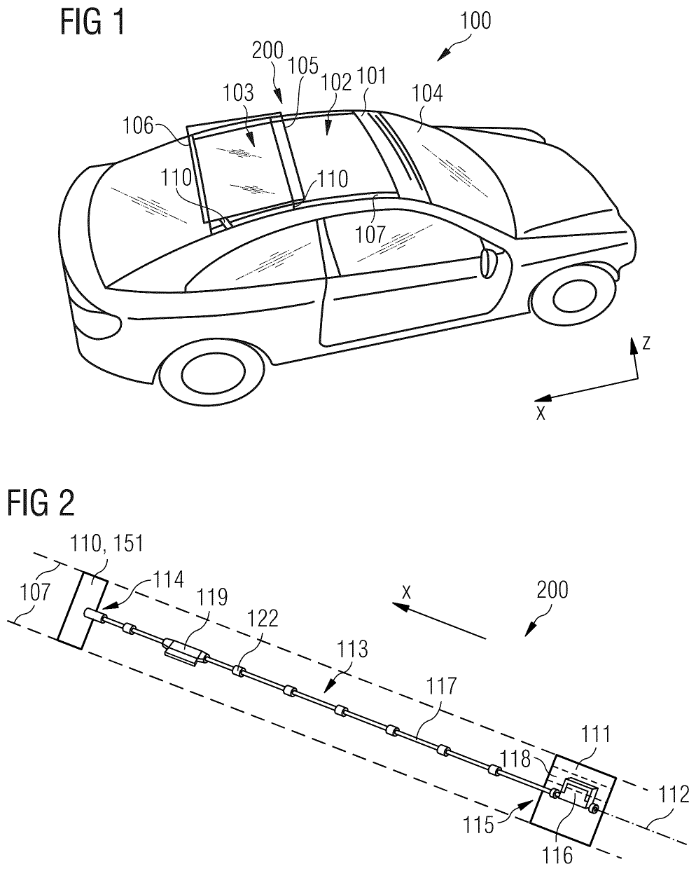

FIG. 1 shows a vehicle 100 according to one exemplary embodiment. The vehicle 100 has a vehicle roof 101. Arranged on the vehicle roof 101 is a cover 103. The cover 103 is movable for example relative to the rest of the vehicle roof 101. Thus, a roof opening 102 can be either closed by the cover 103 or partially opened up.

The vehicle has a windshield 104. The cover 103 has a front edge 105, which, in an operational state, faces the windshield 104. A rear edge 106 of the cover 103 faces away from the windshield 104 in a longitudinal direction X.

The movement of the cover 103 is brought about by means of a deployment mechanism. The deployment mechanism has, for example, a guide rail 107, which is connected to the vehicle roof 101. In the guide rail 107, a drive cable, for example, is guided. The drive cable is, for example, in contact with an electric drive motor and further components of the deployment mechanism in order to move the cover 103 relative to the rest of the vehicle roof 101. The deployment mechanism has an assembly 200, which will be explained in more detail in the following text.

By way of example, the assembly 200 is designed in the manner of a spoiler roof. The mechanical component 110 is in the form of a rear deployment lever 151 (FIG. 2). The rear deployment lever 151 serves to lift the rear edge 106 of the cover 103. When the cover 103 is displaced in the X direction relative to the rest of the vehicle roof and into the open position, the rear deployment lever 151 is locked together with the guide rail 107. The cover 103 is displaced in the X direction relative to the deployment lever 151 in order to be displaced into its open position. In this regard, the exemplary embodiment of a spoiler roof differs from the exemplary embodiment shown in FIG. 1. FIG. 1 illustrates a so-called externally guided sliding roof, in which the deployment lever 151 at the rear edge 106 of the cover 103 is displaced together with the cover 103 in the opening direction relative to the rest of the vehicle roof. The assembly 200 described herein is also usable with this kind of sliding roof and with other configurations of sliding roofs.

Location or direction information that is used, such as rear or front, top or bottom, left or right, is in relation to a vehicle longitudinal axis and a normal direction of travel of an operational vehicle 100. The vehicle longitudinal axis may also be referred to as a horizontal axis or X axis in the associated X direction. The vehicle transverse axis may also be referred to as a horizontal axis or Y axis in the associated Y direction. The vehicle vertical axis may also be referred to as a vertical axis or Z axis in the associated Z direction. The vertical direction, the transverse direction and the longitudinal direction are, in particular, each oriented perpendicularly to one another.

FIG. 2 shows a deployment element 113 of the assembly 200 according to one exemplary embodiment. The deployment element 113 has spring steel element 117 that extends in an elongate manner, or is formed by the spring steel element 117. According to further exemplary embodiments that are not, the deployment element 113 has a different kind of element that extends in an elongate manner, for example a cable exhibiting tensile and compressive stiffness (FIG. 9).

The deployment element 113 extends in an elongate manner along a longitudinal axis 112. The deployment element 113 has a much greater extent along the longitudinal axis 112 than transversely to the longitudinal axis 112.

The deployment element 113 is able to be coupled to a mechanical component 110 (FIG. 2) at a first end 114. The mechanical component 110 is, for example, the deployment lever 151 for moving the cover 103 in the vertical direction Z. According to further exemplary embodiments, the mechanical component 110 is some other element, for example a front deployment lever for moving the cover 103.

During operation, the rear deployment lever 151, which is assigned to the rear edge 106, is locked, for example, relative to the guide rail 107 after the rear edge 106 of the cover 103 has been lifted in the Z direction starting from a closed position. For example, in this state, the rear deployment lever 151 is fixed relative to the guide rail 107 and in particular a relative movement is blocked.

In the closed position, the roof opening 102 is closed by the cover 103. When the cover 103 is subsequently displaced rearwardly in the longitudinal direction X, the rear deployment lever 151 is not moved together with the cover 103. The locking of the rear deployment lever 151 relative to the vehicle roof 101 and the guide rail 107 is brought about, for example, by means of the assembly 200. The deployment element 113 is, in this state, locked relative to the guide rail 107 and, at the first end 114, holds the deployment lever 151 in position. For example, in this state, the deployment element 113 is fixed relative to the guide rail 107 and in particular a relative movement is blocked. For example, the deployment lever 151 is connected directly to the deployment element 113 or by means of further intermediate elements that are not illustrated more explicitly. In particular, rotation between the deployment lever 151 and the deployment element 113 is possible.

A locking protrusion 116 is arranged at a front, second end 115 of the deployment element 113. The locking protrusion 116 is made for example from a plastic. The locking protrusion 116 protrudes radially beyond the deployment element 113. The locking protrusion 116 protrudes in particular perpendicularly beyond the deployment element 113.

Sliding bodies 122 are arranged on the deployment element 113 between the first end 114 and the second end 115. The sliding bodies 122 are made for example from plastic. The sliding bodies 122 have a larger cross section transversely to the longitudinal axis 112 than the deployment element 113.

Between the first end 114 and the second end 115, a guide protrusion 119 is formed on the deployment element 113. The guide protrusion 119 is made for example from a plastic.

The guide protrusion 119 is, for example, spaced apart from each of the first end 114 and the second end 115. The guide protrusion 119 is arranged at a spacing from the locking protrusion 116. The guide protrusion 119 is arranged at a spacing from the mechanical component 110.

The guide protrusion 119 is connected in particular rigidly to the deployment element 113. The guide protrusion 119 protrudes radially beyond the deployment element 113. The guide protrusion 119 protrudes in particular perpendicularly beyond the deployment element 113.

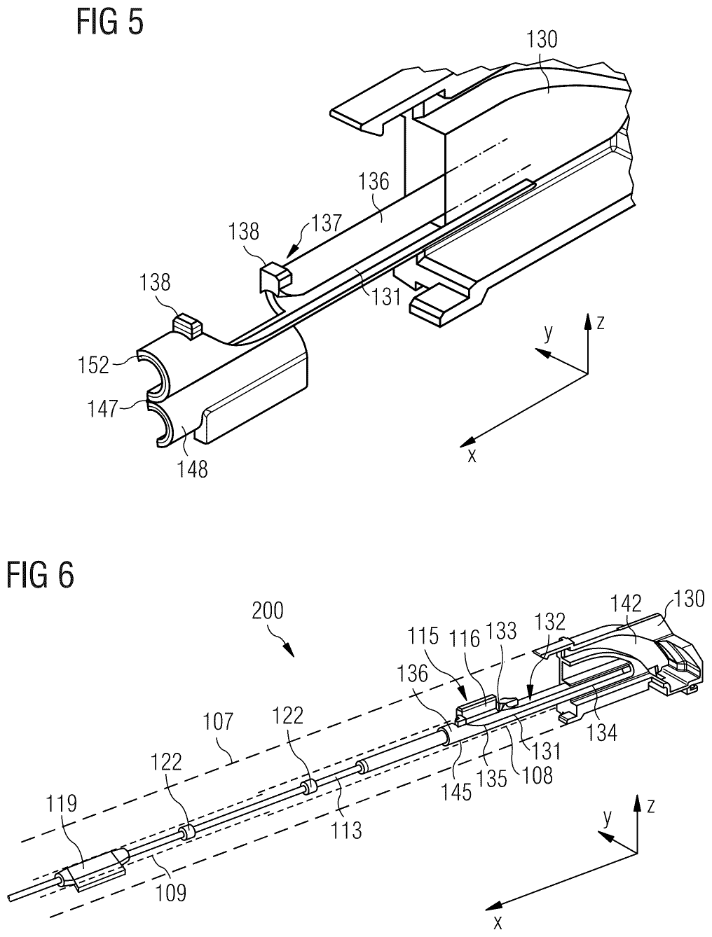

During operation, the guide protrusion 119 is guided in an associated guide track 109 (FIG. 6) of the guide rail 107. The guide track 109 extends longitudinally in the X direction. In particular, the guide protrusion 119 is guided and held by the guide track 109 such that the guide protrusion 119 is displaceable in the X direction relative to the guide rail. Rotation about the longitudinal axis 112 is avoided, however. The guide track 109 of the guide rail 107 thus extends in a straight line.

In order to rotate the locking protrusion 116 about the longitudinal axis 112, the assembly 200 has for example a slide 111. The slide 111 is illustrated only schematically in FIG. 2. The slide 111 is guided in the guide rail 107 and driven for example by a drive cable.

The slide 111 has a slide slotted guide 118. The slide slotted guide 118 serves to guide the locking protrusion 116. The locking protrusion 116 is guided at least partially in the slide slotted guide 118 during operation. The locking protrusion 116 may also at times leave the slide slotted guide 118. When the locking protrusion 116 is not arranged in the slide slotted guide 118, it is possible for the slide 111 to move independently of the locking protrusion 118.

The slide slotted guide 118 has, for example, a helical shape. On account of the helical shape of the slide slotted guide 118, the locking protrusion 116, cooperating with a locking slotted guide 131 in the guide rail 107, is turned about the longitudinal axis 112 or about the longitudinal direction X. The turning takes place in particular through at least 45°.

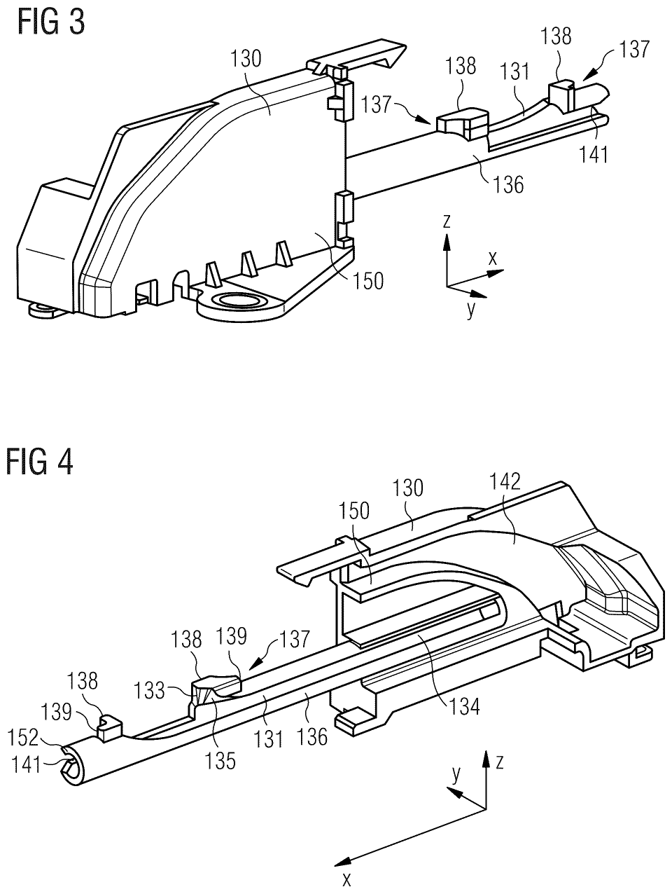

FIGS. 3 and 4 show an exemplary embodiment of a slotted-guide housing 130 in which the locking slotted guide 131 is formed. The slotted-guide housing 130 is manufactured for example from a plastic. The slotted-guide housing 130 is able to be coupled to the rest of the guide rail 107.

The slotted-guide housing 130 has a slotted-guide portion 136 that extends in an elongate manner in the longitudinal direction X. The locking slotted guide 131 is arranged in the slotted-guide portion 136. The locking slotted guide 131 extends in a main direction of extension in the longitudinal direction X. The locking slotted guide 131 has a helical shape 132. The locking slotted guide 131 is designed to guide and to rotate the locking protrusion 116.

The locking slotted guide 131 has a first region 133. The first region 133 is upwardly open in the Z direction. The first region 133 is arranged in a rear region of the slotted-guide portion 136 in the X direction.

The locking slotted guide 131 has a second region 134. The second region 134 extends substantially in the X direction and is closed in the Z direction. The second region 134 is arranged in a region of the slotted-guide portion 136 that faces forward in the X direction.

Formed between the first region 133 and the second region 134 is a transitional region 135. The transitional region 135 extends in a curved manner.

The slotted-guide course of the locking slotted guide 131 guides the turning and rotation of the locking protrusion 116 between a first state, in which the locking protrusion 116 and the deployment element 113 are displaceable in the longitudinal direction X relative to the slotted-guide housing 130, and a second state, in which the locking protrusion 116 and the deployment element 113 are held in the longitudinal direction X so as to be immovable in the longitudinal direction X relative to the slotted-guide housing 130. In the first state, the locking protrusion 116 is arranged in the second region 134. In the second state, the locking protrusion 116 is arranged in the first region 113.

In the first region 133, the locking protrusion 116 is locked and not movable along the X axis relative to the slotted-guide housing 130 and thus relative to the guide rail 107. When the locking protrusion 116 is arranged in the first region 133, the deployment lever 151 is, for example, immovably locked relative to the guide rail 107 by means of the spring steel element 117.

By means of the displacement of the deployment element 113, when the locking protrusion 116 is arranged in the second region 134, the deployment lever 151 is, for example, movable, in particular pivotable, relative to the guide rail 107 in order to lift or lower the rear edge 106 of the cover 103. The locking protrusion 116 is, for example, guided at times both in the slide slotted guide 118 and in the locking slotted guide 131 in order to be moved along the locking slotted guide 131 by means of the slide 111. The cooperation of a helical slide slotted guide and a helical locking slotted guide is described for example in the patent application DE 10 2019 113 142 A1, the entire disclosure of which is hereby incorporated by reference.

Adjoining the first region 133, the slotted-guide housing 130 has a protruding region 137. In the operational state, the protruding region 137 protrudes radially beyond the slotted-guide portion 136 in the Z direction.

The protruding region 137 has two stops 138. The stops 138 each protrude, in the operational state, radially beyond the slotted-guide portion 136 in the Z direction. The stops 138 are each arranged on one side of the first region 133 of the locking slotted guide 131 in the longitudinal direction X. The stops 138 serve to block the locking protrusion 116 toward the front and the rear in the longitudinal direction X. In addition, the stops 138 are each designed to be supported on the guide rail 107 by way of a respective outwardly directed side 139. In the X direction, each stop 138 is supported on the guide rail 107 by way of its side 139 facing away from the first region 133.

The slotted-guide housing 130 has a lifting part 150. The lifting part 150 is formed in a front region of the slotted-guide housing 130 in the longitudinal direction X and has in particular a greater extent in the Z direction than the slotted-guide portion 136 outside the lifting part 150. Formed in the lifting part 150 is a lifting slotted guide 142. The lifting slotted guide 142 serves to guide a slider which faces the front edge 105 of the cover 103. When the slider moves in the lifting slotted guide 142, the front edge 105 is lifted or lowered.

The locking slotted guide is formed partially in the lifting part 150 and partially in the slotted-guide portion 136 outside the lifting part 150. The slotted-guide portion 136 has a cylinder shape outside the lifting part 150. The protruding region 137 protrudes radially beyond the cylinder shape. The second region 134 of the locking slotted guide 131 is formed, for example, partially in the lifting part 150. The first part 133 of the locking slotted guide 131 is formed outside the lifting part 150.

Provided on the slotted-guide portion 136 is an assembling recess 141. The assembling recess 141 serves for the introduction of the locking protrusion 116 into the locking slotted guide 131.

The assembling recess 141 is formed in particular on the slotted-guide portion 136 at a free end 152 facing away from the lifting part 150. The assembling recess 141 is open in the X direction at the free end 152 such that the locking protrusion 116 can be introduced into the slotted-guide portion 136 counter to the X direction. In first region recess the 133, the assembling 141 transitions into the locking slotted guide 131 such that the locking protrusion 116 can be introduced from the assembling recess 141 into the locking slotted guide 131. At the transition from the assembling recess 141 into the locking slotted guide 131, the locking protrusion 116 is rotated about the longitudinal axis 12.

The free end 152 of the slotted-guide portion 136 faces away from the lifting part 150 along the longitudinal axis X.

FIG. 5 shows the slotted-guide housing 130 according to a further exemplary embodiment. The slotted-guide housing 130 corresponds substantially to the slotted-guide housing 130 of the other exemplary embodiment described herein. By contrast, the slotted-guide housing 130 according to FIG. 5, rather than the assembling recess 141, has a hinge 147 and a closing part 148. The slotted-guide portion 136 is radially open on one side at the free end 152. At the opening, the locking protrusion 116 can be introduced into the locking slotted guide 131. The opening is closable by means of the closing part 148. The closing part 148 is fastened to the slotted-guide portion 136 by means of the hinge 147. The closing part 148 is thus able to be flapped open for the assembly of the locking protrusion 116 and able to be flapped closed following assembly.

FIG. 6 shows the slotted-guide body 130 in its state coupled to the guide rail 107. The guide rail 107 is illustrated only schematically. In addition, the deployment element 113 is fitted in the guide rail and the slotted-guide housing 130 by way of the locking protrusion 116. The locking protrusion 116 is arranged in the first region 133 of the locking slotted guide 131 such that displacement in the X direction relative to the guide rail 107 is blocked.

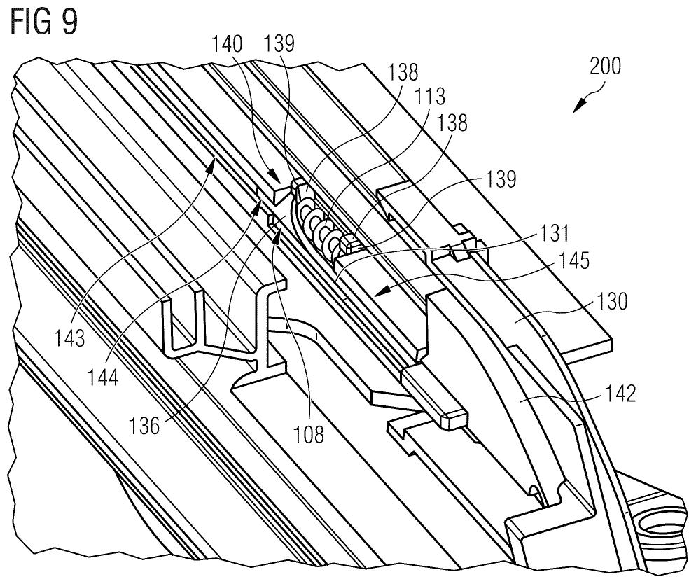

The guide rail has a guide channel 108 for the deployment element 113. The guide channel 108 is also illustrated in FIG. 8.

The guide channel 108 serves to guide the longitudinal movement of the deployment element 113. For example, the sliding bodies 122 are in contact with the guide rail 107 in the guide channel 108. The slotted-guide portion 136 is arranged in an end portion 145 of the guide channel that is at the front in the X direction and faces the slotted-guide housing 130. Starting from the lifting part 150, the slotted-guide portion 136 extends in the longitudinal direction X in the guide channel 108 of the guide rail 107. The guide channel 108 radially surrounds the slotted-guide portion 136 at least partially. Thus, the slotted-guide portion 136 is supported and stabilized by the guide rail 107.

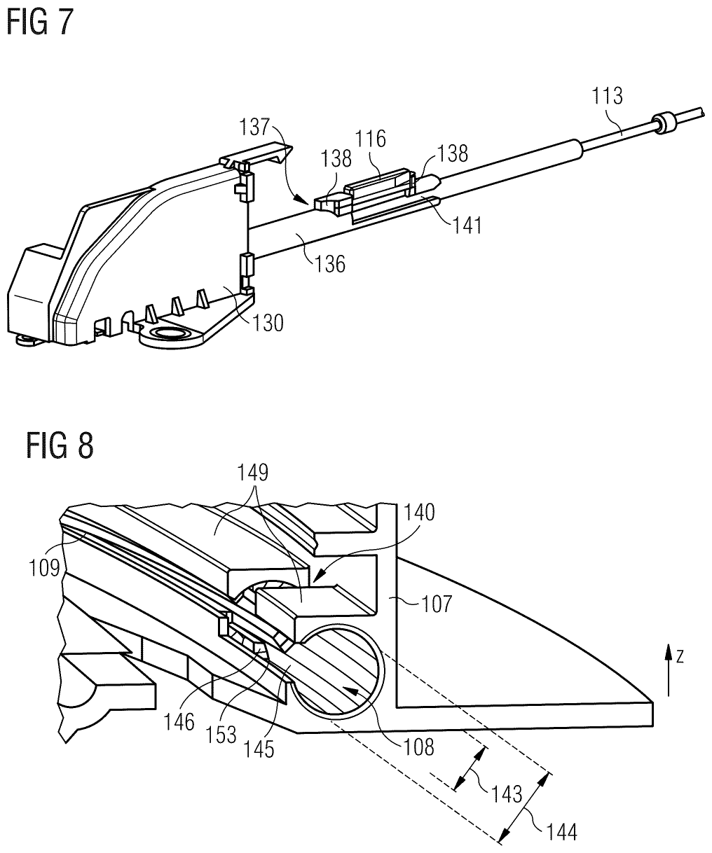

FIG. 7 shows the housing body 130 with the deployment element 113 assembled. The locking protrusion 116 has been inserted through the assembling recess 141 and subsequently rotated between the stops 138. In this state, it is possible to insert the slotted-guide housing 130 together with the locking protrusion 116 and the deployment element 113 into the guide rail 107.

FIG. 8 shows a detail view of the guide rail 107 at an end facing the slotted-guide housing 130. The guide channel 108 has a first cross section 143 outside the end portion 145. The first cross section 143 is formed for example by a profile 146. The profile 146 has, for example, protrusions, undercuts, set-back regions or other shapes. The first cross section 143 is adapted such that the sliding bodies 122 bear radially against and are guided by the guide channel 108.

In the end portion 145, the guide channel 108 has a second cross section 144. The second cross section 144 is larger than the first cross section 143. For example, in the second cross section 144, the profile 146 has been removed. The second cross section 144 is large enough for the slotted-guide portion 136 to be able to be inserted into the guide channel 108.

Formed in the end portion is an insertion slot 153 that extends in the X direction. The insertion slot 153 is in contact with a recess 140. The recess 140 has been introduced into the top of the guide rail in the Z direction. The recess 140 has been introduced into an upper profile wall 149 of the guide channel 108.

For assembly, the slotted-guide portion 136 is inserted into the guide rail 107 such that the protruding region 147 is guided through the insertion slot 153. In the region of the recess 140, the protruding region 137 and thus the slotted-guide portion 136 and the slotted-guide housing 130 are rotated about the longitudinal direction X, such that the protruding region 137 is arranged in the recess 140.

The profile 146 has been removed from the end portion 145 for example by drilling, milling or in some other way.

FIG. 9 shows the assembly 200 in the operational state. The protruding region 137 is arranged in the recess 140. The assembling recess 141 is closed by the guide rail 107. The stops 138 are supported against the profile wall 149 by their respective sides 139. The slotted-guide portion 136 extends through the end portion 145 as far as the region of the guide channel 108, where the profile 136 with the first cross section 143 is formed.

The deployment element 113 extends through the guide channel 108 and through the slotted-guide portion 136. The guide protrusion 119 is guided only in the slotted-guide portion 136.

In FIG. 9, the deployment element 113 is illustrated in the form of a cable exhibiting tensile and compressive stiffness, in the manner of a drive cable. According to further exemplary embodiments, the deployment element 113 is formed in some other way, for example in the manner of a spring steel element 117.

The assembly 200 allows the deployment element 113 to be locked and unlocked by means of rotation about the longitudinal axis 112. For this purpose, simple assembly is possible and the helical locking slotted guide 131 is able to be integrated readily into the rest of the roof concept. The locking protrusion 116, which is configured for example as a locking pin, is guided in the one-piece locking slotted guide 131 in the slotted-guide housing 130 and does not have to be guided over joints for example between the slotted-guide housing 130 and the guide rail 107. Thus, noise emissions are able to be reduced. The deployment element 113 is able to be fitted without complicated reworking. The slotted-guide portion 136 is held and supported sufficiently stably by the guide rail 107 such that, in spite of the helical slotted guide 131, undesired deformations of the locking slotted guide 131 are avoided.

Assembly by means of insertion of the slotted-guide housing 130 and of the protruding region 137 through the insertion slot 153 as far as the recess 140 allows a closed guide rail 107 on the side facing away from the insertion slot 143. Thus, the guide rail 107 is designed such that it can surround, and thus support, the slotted-guide portion 136 as far as possible peripherally. Assembly of the deployment element 113 with the slotted-guide housing 130 is possible during the assembly of the sliding roof, and the deployment element 113 and the slotted-guide housing 130 can be produced separately from one another. For example, the deployment element 113 is first of all introduced into the guide channel 108 such that the deployment element 113 protrudes with the locking protrusion 116 beyond the guide rail 107. In this state, the locking protrusion 116 is introduced into the locking slotted guide 131 by means of the assembling recess 141. Subsequently, the slotted-guide housing 130 is pushed, together with the deployment element 113, toward the guide rail 107 and coupled to the guide rail 107.

The end portion 145 of the guide channel 108 is designed such that, with the exception of the insertion slot 153 and the recess 140, it entirely surrounds the slotted-guide portion 136 in particular radially. The second cross section 144 is precisely millable, for example with the aid of a pilot pin. This makes it possible to avoid drifting of the milling cutter, and the coaxial orientation of the milling allows precise and tangentially constant milling and/or chamfering of the guide channel 108 with the first cross section 143. In this way, chattering points are avoidable.

For the first region 133 and the stops 138, the recess 140 has additionally been introduced into the guide rail 107 and the guide channel 108. Axial forces during the locked state are thus introduced directly into the guide rail 107 by means of the stops 138. Thus, excessive loading of the plastic in the slotted-guide portion 136 is avoided. The forces are diverted via the guide rail 107 as far as a screwing point with the vehicle housing or the like. In addition, the slotted-guide portion 136 is supported axially against the guide channel 108 with the first cross section 143 such that, here too, axial forces are diverted from the slotted-guide portion 136 into the guide rail. As a result of the contact of the outer sides 139 of the stops 138 with the guide rail 107, the slotted-guide portion 136 is able to be locked in place with little or no play, in order to support forces.

The locking protrusion 116 has been guided along its entire travel length in the one-piece locking slotted guide 131. This avoids joints, which could act as chattering points.

Since the slotted-guide portion 136 is supported by the guide rail 107 on all sides, it is possible to form the assembling recess 141 or other openings for assembling the deployment element 113, which are closable by means of the closing part 148. The guide channel 108 engages around the slotted-guide portion 136 and thus holds the deployment element 113 and the locking protrusion 116 and/or for example the closing part 148 in position, such that undesired escaping of the locking protrusion 116 from the locking slotted guide 131 is avoided.

The assembly 200 having the helical locking slotted guide 131 is thus easy to assemble and to be attached to the guide rail 107. The slotted-guide housing 130 and the slotted-guide portion 136 are supported robustly and loads that arise during operation at the locking slotted guide 131 are passed on to the guide rail 107. The guide rail 107 supports the locking slotted guide 131 such that impermissible deformations of the locking slotted guide 131 are avoided by the engaging support and direct diversion of the loads. Thus, the assembly 200 is able to be formed in a stable and reliable manner while having a small space requirement.

### REFERENCE SIGNS

100 Vehicle
101 Vehicle roof
102 Roof opening
103 Cover
104 Windshield
105 Front edge
106 Rear edge
107 Guide rail
108 Guide channel for the deployment element
109 Guide track for the guide protrusion
110 Mechanical component
111 Slide
112 Longitudinal axis
113 Deployment element
114 First end
115 Second end
116 Locking protrusion
117 Spring steel element
118 Slide slotted guide
119 Guide protrusion
122 Sliding body
130 Slotted-guide housing
131 Locking slotted guide
132 Helical shape
133 First region
134 Second region
135 Transitional region
136 Slotted-guide portion
137 Protruding region
138 Stop
139 Side
140 Recess
141 Assembling recess
142 Lifting slotted guide
143 First cross section
144 Second cross section
145 End portion
146 Profile
147 Hinge
148 Closing part
149 Profile wall
150 Lifting part
151 Deployment lever
152 Free end
153 Insertion slot
200 Assembly
X Longitudinal direction
Y Transverse direction
Z Vertical direction

1. An assembly for moving a cover for a vehicle roof, having:
a guide rail which extends in a longitudinal direction,
a slotted-guide housing which has a slotted-guide portion that extends in an elongate manner in the longitudinal direction, wherein a locking slotted guide is formed in the slotted-guide portion, wherein the locking slotted guide has a helical shape,
a deployment element having a radially protruding locking protrusion which cooperates with the locking slotted guide in order to rotate the locking protrusion about the longitudinal direction during operation, wherein
the slotted-guide housing has a radially protruding region and the guide rail has a recess, and the protruding region is arranged in the recess in an assembled state.

2. The assembly according to claim 1, wherein the protruding region has two stops for the locking protrusion, and a first portion of the locking slotted guide is arranged between the two stops in the longitudinal direction.

3. The assembly according to claim 2, wherein
the locking protrusion is arranged, in a locked state, between the two stops in the longitudinal direction, and
the two stops are supported on the guide rail at their respective sides facing away from the locking protrusion in the longitudinal direction.

4. The assembly according to claim 1, wherein the slotted-guide housing has an assembling recess which is connected to the locking slotted guide and by means of which the locking protrusion is insertable into the locking slotted guide.

5. The assembly according to claim 1, wherein the slotted-guide housing has a lifting slotted guide for lifting and lowering the cover.

6. The assembly according to claim 1, wherein the guide rail has a guide channel in which the deployment element is guided, wherein the slotted-guide portion of the slotted-guide housing is arranged at least partially in the guide channel.

7. The assembly according to claim 6, wherein the guide channel has a first cross section transversely to the longitudinal direction and has a second cross section in an end portion facing the slotted-guide housing, wherein the second cross section is larger than the first cross section and the slotted-guide portion is arranged in the end portion.

8. The assembly according to claim 1, wherein the slotted-guide portion has a circular cylindrical shape.

9. A method for assembling an assembly for moving a cover for a vehicle roof, comprising:
providing a guide rail which extends in a longitudinal direction,
providing a slotted-guide housing which has a slotted-guide portion that extends in an elongate manner in the longitudinal direction and has a radially protruding region,
inserting the slotted-guide portion into the guide rail,
rotating the slotted-guide housing about the longitudinal direction until the protruding region is arranged in a recess in the guide rail, and as a result
locking the slotted-guide housing in place in the guide rail by means of the radially protruding region, at least in the longitudinal direction.

10. The method according to claim 9, comprising:
providing a deployment element having a radially protruding locking protrusion,
introducing the locking protrusion into a locking slotted guide which is formed in the slotted-guide portion, before the slotted-guide housing is locked in place in the guide rail.
